(19) United States
(12) Patent Application Publication
(10) Pub. No.: US 2011/0147972 A1
(43) Pub. Date: Jun. 23, 2011

(54) HOPPER FOR DISCHARGING CONCRETE INTO A MOLD

(76) Inventor: Wayne J. Buoni, New Albany, OH (US)

(21) Appl. No.: 12/640,366

(22) Filed: Dec. 17, 2009

(51) Int. Cl. B29C 39/44

(52) U.S. Cl. 264/40.4; 425/145; 425/148

(57) ABSTRACT

A method and apparatus for discharging a dose of castable building material into a mold include introducing a supply of castable building material into a hopper. The castable building material in the hopper is spread evenly within the hopper. A mold configured to form a molded building product is positioned beneath the hopper, and the castable building material is discharged from the hopper into the mold. In one embodiment a discharge gate is configured to discharge the castable building material evenly into the mold while substantially reducing the need for lateral movement of the castable building material in the mold.

### BACKGROUND

Molded building products, such as simulated stone or brick and the like, can include simulated stone or brick veneers and simulated stone or brick architectural trim products that may be used for a variety of building applications. These molded building products are manufactured using a molding process in which the molds are typically taken from the shapes and contours of natural stones or bricks. The molds generally include a mold cavity filled with a castable building material, including the non-limiting example of concrete. After the castable building material has cured, or set, the simulated stone or brick products are removed from the mold.

The molding process can be time consuming and expensive due to the amount of time and labor required to adequately fill the mold. For example, to ensure sufficient filling of the mold it is known to initially overfill the mold directly with concrete and then screed the top layer of the mold in order to level the concrete and to remove the excess amount of concrete from the mold. In an attempt to improve cycle time and increase productivity, the concrete may be delivered directly to the mold using multiple doses and/or separate supply channels. After an amount of concrete is delivered to the mold, it is also known to weigh the mold in order to determine the quantity of concrete delivered into the mold. Once the mold is filled, the mold can then be vibrated to evenly spread the concrete and ensure sufficient filling of the mold cavities. These filling and spreading procedures can be performed within the mold during the production process.

Thus, there exists a need in the art for improved methods and apparatus for discharging castable building material into a mold.

### SUMMARY

This invention relates to a method for discharging a dose of castable building material into a mold. The method includes introducing a supply of castable building material into a hopper. The quantity of castable building material in the hopper is controlled to introduce a predetermined quantity. The castable building material is then spread evenly within the hopper. A mold configured to form a molded building product is provided, and the castable building material is discharged from the hopper into the mold.

According to one embodiment, there is provided a method for discharging a dose of castable building material into a mold, the method including providing a mold configured to form a molded building product. A hopper having a discharge opening is provided, where the shape of the discharge opening substantially corresponds to the shape of the mold. A supply of castable building material is supplied into the hopper, and the castable building material is spread evenly within the hopper. The castable building material is discharged from the hopper evenly into the mold. The even spreading of the castable building material in the hopper substantially reduces the need for lateral movement of the castable building material in the mold.

According to another embodiment, there is also provided apparatus for discharging a dose of castable building material into a mold. The apparatus includes a hopper having a discharge opening. The hopper is capable of receiving castable building material and discharging the castable building material into the mold. A vibration inducing mechanism is configured to evenly spread the castable building material within the hopper. Positioned beneath the hopper is a mold. A discharge gate is connected to the hopper and in direct communication with the discharge opening. The discharge gate is configured to discharge the castable building material evenly into the mold while substantially reducing the need for lateral movement of the castable building material in the mold.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a diagrammatical view of an apparatus for discharging castable building material into a mold assembly in accordance with an embodiment of the invention.

FIG. 2 is a cross-sectional side view of the hopper shown in FIG. 1.

FIG. 3 is a partially cut away perspective view of a hopper according to an embodiment of the invention.

FIG. 4 is a perspective view of a hopper according to another embodiment of the invention.

FIG. 5 is a perspective view of a mold assembly corresponding to the hopper shown in FIG. 4.

FIG. 6 is a perspective view of a hopper according to another embodiment of the invention.

FIG. 7 is a perspective view of a mold assembly corresponding to the hopper shown in FIG. 6.

### DETAILED DESCRIPTION OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

The term “concrete” as used throughout the specification and claims is intended to define any castable, inorganic building material suitable for the manufacturing of molded building products. The term “mold assembly” as used throughout the specification and claims is intended to define any suitable device configured for molding building products and may include a single mold cavity or multiple mold cavities of varying shapes and sizes. The term “hopper” as used throughout the specification and claims is intended to define any container or vessel adapted for storing or holding an amount of castable building material, and capable of discharging the castable building material. The term “discharge gate” as used throughout the specification and claims is intended to define any structure configured to selectively retain an amount of castable building material within a hopper or to selectively discharge the amount of castable building material from the hopper. The term “vibration inducing mechanism” as used throughout the specification and claims is intended to define any mechanism configured to generate a vibrating or pulsating sensation. The term “evenly distribute” or “evenly spread” as used throughout the specification and claims refers to providing a substantially level or even top surface of the castable building material while also eliminating or substantially reducing cavities or voids within the castable building material. The term “load cell assembly” as used throughout the specification and claims is intended to define any system or apparatus for measuring or sensing the weight of an object and adapted for providing an output signal indicative of the sensed weight. The term “control unit” as used throughout the specification and claims is intended to define any general purpose, programmable device adapted to receive input signals and deliver output signals.

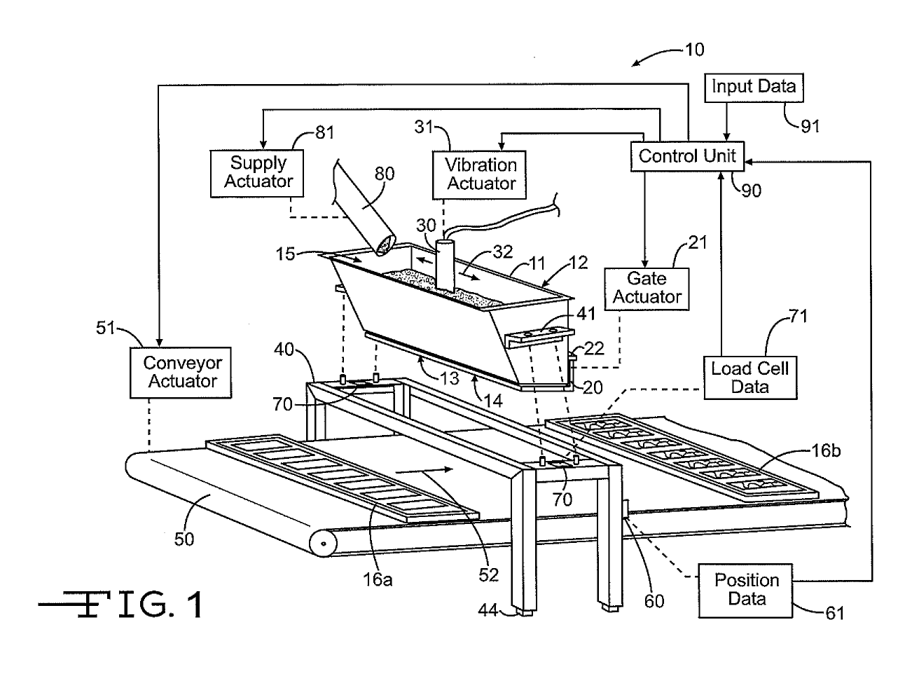

Referring now to the drawings, there is illustrated in FIG. 1 an apparatus 10 for discharging a dose of castable building material into a mold assembly for producing molded building products. Two mold assemblies of a continuous production process are diagrammatically shown in the drawing illustrating an unfilled mold assembly 16a and a filled mold assembly 16b. When describing the structure of the apparatus 10, the unfilled mold assembly 16a and the filled mold assembly 16b will be referred to generally as a mold assembly 16 for ease of description. As noted, the apparatus 10 is configured for discharging a dose of concrete and other castable building materials into the mold assembly 16. It is to be understood that any suitable castable building material can be used for producing the molded building products. In one embodiment, the castable building material can be a lightweight concrete material comprising Portland cement, lightweight aggregates and mineral oxides. By way of example and not of limitation, other castable materials are also useful, such as plaster of Paris or a ceramic based material. However, the apparatus 10 will be described below specifically with respect to the dosing of concrete into the mold assembly 16 and it should be understood that the term “concrete” as used herein includes any other castable, inorganic building materials which may be discharged in accordance with the apparatus 10.

As an initial consideration, the quantity of concrete required to fill the desired mold assembly 16 is established, the quantity being referred to herein as the “predetermined quantity.” If the mold assembly 16 is filled to an extent that the filled quantity exceeds the predetermined quantity, then undesirable effects on the production process and the production equipment associated with producing such molded building products can result. On the other hand, if the filled quantity of the mold assembly 16 is substantially less than the predetermined quantity, then the end product can be unacceptable and fail to meet required specifications. In addition, the production time for manufacturing such molded building products can be dramatically reduced by ensuring that the predetermined quantity is effectively discharged within the mold assembly 16.

Furthermore, particular aspects of discharging concrete into the mold assembly 16 are helpful to ensure adequate spreading of the concrete within the mold assembly 16. If the concrete is discharged within the mold assembly 16 in an uneven or inconsistent manner, then the concrete must subsequently be spread laterally within the mold assembly 16 in order to adequately and completely fill the mold cavities. Likewise, the production time of manufacturing such molded building products can be dramatically reduced by eliminating or reducing the amount of time needed to evenly spread the discharged concrete within the mold assembly 16.

Accordingly, it is desirable to fill each mold assembly 16 with a precise quantity of concrete so that the filled quantity of each mold assembly 16 is as close as possible to the predetermined quantity. It is also desirable to effectively spread the concrete prior to discharging the concrete into the mold assembly 16. The apparatus 10 enables a dose of concrete to be discharged into a mold assembly 16 so the filled quantity and distribution of the mold assembly 16 more closely approximates the ultimately desired quantity and distribution, and further substantially reduces or eliminates the need to subsequently evenly spread the concrete within the mold assembly 16.

In general, a supply of concrete is delivered from a concrete transport system 80 to a hopper 11. The supply of concrete is selectively delivered to the hopper 11 until the predetermined quantity is obtained, at which point the supply of concrete is stopped. The predetermined quantity of concrete is then spread evenly within the hopper 11. When a mold assembly 16 has been conveyed to a position located directly beneath the hopper 11, the predetermined quantity of evenly spread concrete is discharged from the hopper 11 into the mold assembly 16.

The concrete transport system 80 is adapted to selectively transfer concrete from a storage location not shown) and deliver the concrete into the hopper 11. For example, in the illustrated embodiment, the concrete transport system 80 may include a supply pipe having a screw conveyor disposed therein for effectively delivering a supply of concrete to the hopper 11. In another embodiment, the concrete is supplied to the hopper 11 in any other manner, such as by a larger overhead storage hopper or standard conveyor system, sufficient to selectively supply a quantity of concrete into the hopper 11.

The hopper 11 is an upwardly facing container having an upper open 12 end and a lower discharge end 13. The hopper 11 includes an internal cavity 15 adapted to receive a supply of concrete from the concrete transport system 80. The hopper 11 may be tapered inwardly toward the lower discharge end 13 forming a discharge opening 14. It should be fully understood that the hopper 12 can be made of any material, such as metal or reinforced plastic, sufficient to initially store the concrete and then discharge the concrete into the mold assembly 16. It should also be fully understood that the internal surfaces of the hopper 11 may be coated or lined with an anti-friction material suitable to facilitate full discharge of the concrete from the internal cavity 15 of the hopper 11 into the mold assembly 16 and be corrosive resistant. By way of example and not of limitation, a Teflon® based material has been found to perform such functions in a desired fashion.

The lower discharge end 13 defines the discharge opening 14 through which the predetermined quantity of concrete can be discharged. The discharge opening 14 may have a shape that substantially corresponds with the shape of the mold assembly 16. As the concrete is discharged from the hopper 11 into the mold assembly 16, the dose of concrete adequately fills the mold assembly 16 evenly across the surface area of the mold assembly 16. This configuration can substantially reduce the lateral flow of the concrete required within the mold assembly 16. By substantially reducing or eliminating the need to subsequently spread the concrete once the material has been delivered into the mold assembly 16, the cycle time can be reduced and therefore the rate of production can be increased.

As illustrated in FIG. 1, the mold assembly 16 has a rectangular cross-sectional shape taken along the major plane and, therefore, the discharge opening 14 substantially corresponds with the rectangular cross-sectional shape taken along the major plane of the mold assembly 16. The illustrated cross-sectional shape of the mold assembly 16 and the discharge opening 14 in FIG. 1 are not intended to be limiting. The mold assembly 16 may have any cross-sectional shape applicable to facilitate the efficient and cost effective manufacture of molded building products. By way of illustration and not of limitation, there is shown in FIG. 4 a perspective view of the hopper 11 incorporating a second embodiment of this invention. A corresponding mold assembly 16 is shown in FIG. 5. As illustrated, the cross-sectional shape of the discharge opening 14 and the corresponding mold assembly 16 may be “L” shaped, or may have any other suitable cross-sectional shape for molding. Furthermore, the hopper 11 may be configured to take into account a mold assembly 16 that requires increased amounts of concrete at certain locations within the mold assembly 16, i.e., separate or distinct quantities of concrete at specific locations within the mold assembly.

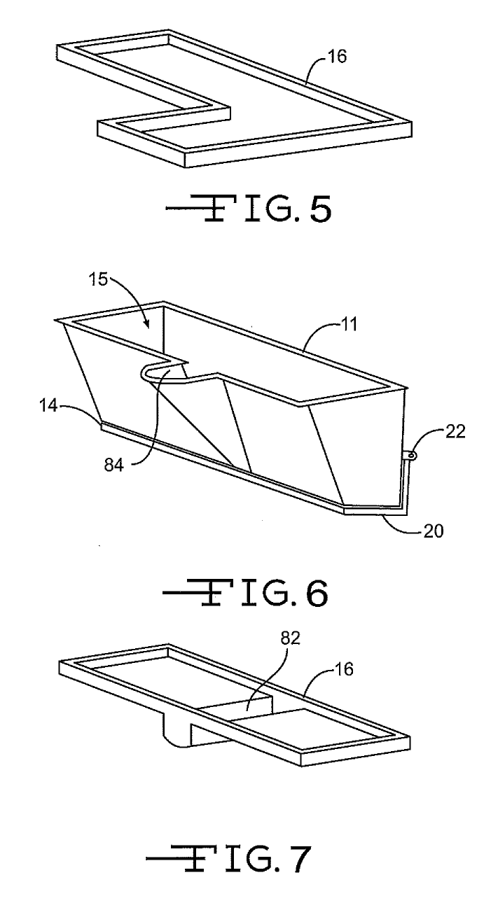

By way of illustration and not of limitation, there is shown in FIG. 6 a perspective view of the hopper 11 incorporating a third embodiment of this invention, along with the corresponding mold assembly 16 as shown in FIG. 7. The cross-sectional shape of the discharge opening 14 substantially corresponds with the cross-sectional shape of the mold assembly 16. Further, as illustrated, the shape of the hopper 11 may include an extended portion 84 that is configured to discharge an increased amount of concrete at a desired location. The mold assembly 16 shown in FIG. 6 includes a section 82 having a greater depth than the depth of the remainder of the mold assembly 16. In order to assure that the concrete discharged into the mold 16 needs substantially no additional distribution once discharged into the mold assembly 16, the hopper 11 is configured with the section 84 to increase the volume of concrete in the portion of the hopper 11 corresponding to the section 82 of greater depth in the mold assembly 16. It can be seen the hopper is configured to discharge a distinct quantity of castable material at a specified location within the mold, wherein the specified location has a differing depth than the remainder of the mold.

Referring again to FIG. 1, it should also be understood that the cross-sectional area of the discharge opening 14 need not substantially correspond to the cross-sectional area of the mold assembly 16, although it may. Such a determination can be based on various factors such as the size of the mold assembly 16, the quantity of concrete being discharged, the depth and volume requirements of the mold Additionally 16, and the consistency of the concrete selected for producing the desired molded building products. In one embodiment, the cross-sectional area of the discharge opening 14 is slightly smaller than that of the mold assembly 16 to eliminate the potential for spilling or splashing of concrete during the discharging step. Even if the discharge opening is smaller than the mold, the shape of the discharge opening 14 can still correspond to the shape of the mold assembly 16.

As best shown in FIG. 2, the hopper 11 includes a discharge gate 20 which is connected to the lower discharge end 13 of the hopper 11 by a hinge 22. The discharge gate 20 is in direct communication with the discharge opening 14 and the internal cavity 15 of the hopper 11. The discharge gate 20 has an opened position (as illustrated by the dashed lines) and a closed position. In the closed position of the discharge gate 20 the concrete is retained in the internal cavity 15 of the hopper 11. In the opened position the concrete in the internal cavity 15 is discharged from the hopper 11 through the discharge opening 14. As illustrated, the discharge gate 20 is a single gate-like structure with hinge 22 that is offset from the discharge opening 14 a distance B to allow the discharge gate 20 to fully pivot from contact with the discharge opening 14 for maximum discharge of the concrete in a single dose. The discharge gate 20 is configured to discharge the concrete such that a single dose of concrete may be discharged evenly into the mold assembly 16 in a consistent and uniform manner. Alternatively, the discharge gate 20 may be a sliding style gate or may include a combination of multiple trap-style gates in a clam-shaped configuration, sufficient to allow the concrete to flow from the hopper 11 to the mold assembly 16 in the manner described above. Furthermore, the discharge opening 14 may define a plane that is angled in an upward direction relative to a horizontal plane, as shown by the reference A in FIG. 2, to help prevent leakage of concrete when the discharge gate 20 is in the closed position. This configuration substantially reduces the need for a sealing device between the discharge opening 14 and the discharge gate 20.

Referring again to FIG. 1, a discharge gate actuator 21 is mechanically connected to the discharge gate 20 for the purpose of controlling movement of the discharge gate 20. The discharge gate actuator 21 is adapted to move the discharge gate 20 to the opened position in response to receiving an open signal and to move the discharge gate 20 to the closed position in response to receiving a close signal. The discharge gate actuator 21 may include an actuating cylinder not shown) to operatively move the discharge gate 20 between the opened and closed positions. It should be understood that the actuating cylinder may be pneumatically operated or hydraulically operated, or may be operated by any other suitable source for movement of the discharge gate 20. Alternatively, the discharge gate actuator 21 may be embodied as an electric motor (not shown) for operatively moving the discharge gate 20 between the opened and closed positions.

The apparatus 10 includes at least one vibration inducing mechanism 30. The vibration inducing mechanism 30 is configured to spread or disperse the concrete evenly within the internal cavity 15 of the hopper 11. In the illustrated embodiment, the apparatus 10 includes an internal vibration inducing mechanism 30 configured to be partially submersed in and in direct contact with the concrete located within the internal cavity 15 of the hopper 11. However, it should be appreciated that any combination or configuration of vibration inducing mechanisms 30 may be incorporated into the apparatus 10. For example, a single vibration inducing mechanism (not shown) may be connected to an external portion of the hopper 11 for operatively vibrating the hopper 11 in order to spread the concrete. The apparatus 10 may include any combination of external and internal vibration inducing mechanisms suitable to evenly spread the concrete within the internal cavity 15 of the hopper 11. The internal vibration inducing mechanism 30 may also be supported for movement along a horizontal path, indicated by arrow 32, within the internal cavity 15 of the hopper 11. As illustrated in FIG. 1, the vibration inducing mechanism 30 may be configured to oscillate along the horizontal path 32, or in any other motion suitable for spreading the concrete evenly within the internal cavity 15.

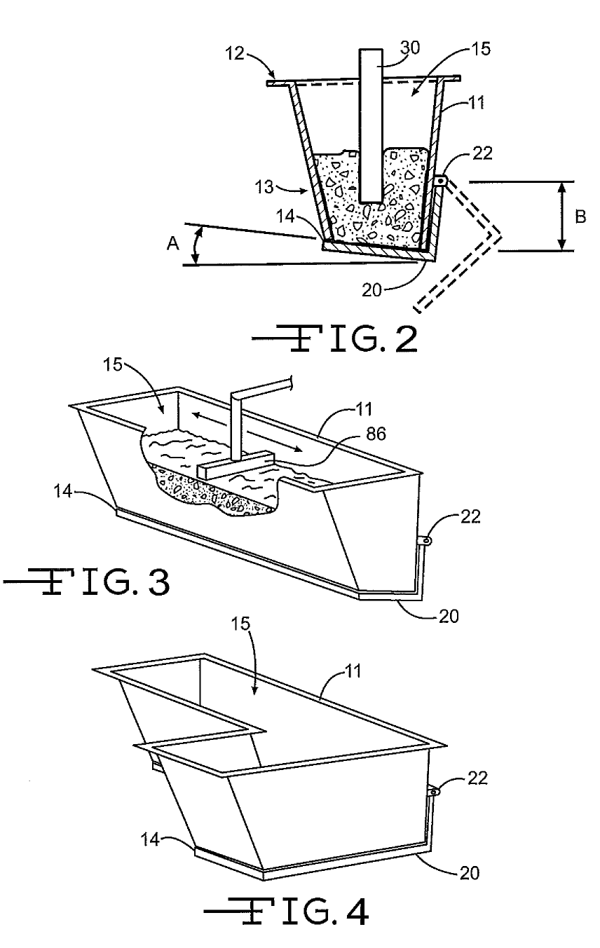

As shown in FIG. 3, the apparatus 10 may optionally include a spreading member 86 configured to spread or disperse the concrete evenly within the internal cavity 15 of the hopper 11. By way of example, the spreader may be a spreader screen, spreader block, screeding plate, stirring knife, or any other object that may be configured to move along the horizontal path 32, or in any other motion suitable for spreading the concrete evenly within the internal cavity 15.

As illustrated in FIG. 1, the hopper 11 is supported from the ground by a structure such as a hopper frame assembly 40. The hopper frame assembly 40 is configured such that the discharge opening 14 of the hopper 11 is disposed generally above the mold assembly 16 so that concrete can be discharged from the internal cavity 15 of the hopper 11 into the mold assembly 16. The hopper 11 may include supports 41 fixed to an external portion of the hopper 11 in any suitable manner for supporting the hopper 11 on the frame assembly 40. The hopper supports 41 are then connected to the hopper frame assembly 40 as illustrated by the broken lines in FIG. 1. The hopper supports 41 are connected to the hopper frame assembly 40 in such a manner so as to enable the apparatus 10 to accommodate hoppers with varying sizes and shapes as required for the size and shape of a desired mold assembly. Although this is the illustrated embodiment, it should be appreciated that the hopper 11 may be supported in any suitable fashion.

The hopper frame assembly 40 may also include frame height adjusters 44 for selectively adjusting the vertical distance between the discharge opening 14 of the hopper 11 and the mold assemblies 16 thereby accommodating mold assemblies 16 of varying heights. The frame height adjusters 44 may also provide sufficient clearance between the discharge gate 20 in the opened position and a top surface of the mold assembly 16. The frame height adjusters 44 may also be adapted to effectively level the hopper frame assembly 40. The frame height adjusters 44 may be any height adjusters suitable for carrying out the purposes described above. The location and configuration of the frame height adjusters 44 as illustrated in FIG. 1 are by way of example and not of limitation. Thus, the frame height adjusters 44 may be configured in any suitable manner for adjusting the height of the hopper 11 relative to the mold assembly 16.

A load cell assembly 70 is mechanically connected between the hopper frame assembly 40 and the hopper supports 41. The load cell assembly is adapted to sense the weight of the concrete as the concrete is being delivered into the internal cavity 15 of the hopper 11. The load cell assembly 70 is further adapted to provide an output signal indicative of the sensed weight of the concrete being loaded into the internal cavity 15 of the hopper 11. The load cell assembly 70 is a dynamic weighing system so that an output signal is continuously generated to provide a continuous indication of the weight of the concrete being delivered to the internal cavity 15 of the hopper 11 by the concrete transport system 80. The load cell assembly 70 may comprise a single load sensor or a plurality of load sensors (two being shown in FIG. 1) that are constructed and adapted to provide the output signal in the manner described above. Load sensors that are adapted to be disposed between the hopper frame assembly 40 and the hopper supports 41 and that provide output signals indicative of the weight of the hopper 11 are commercially available. The location and configuration of the load cell assembly 70 as illustrated in FIG. 1 is by way of example and not of limitation. The load cell assembly 70 may be configured in any suitable manner to effectively sense the weight of the concrete in the internal cavity 15 of the hopper 11.

A damping system (not shown) may be incorporated between the hopper frame assembly 40 and the hopper supports 41. The damping system may include any system suitable to reduce or eliminate vibrations generated by the vibration inducing mechanism 30 from being transferred into the hopper frame assembly 40 so as to possibly affect the operation or accuracy of the load cell assembly 70. The dampening system is also configured to substantially reduce the operating noise of the apparatus 10 produced by the moving elements, such as the vibration inducing mechanism 30 and the gate actuator 21.

The concrete dosing apparatus 10 may include a conveyor assembly 50. The conveyor assembly 50 is located beneath the hopper 11 and is provided with an endless belt. The conveyor assembly 50 includes a conveyor actuator 51 for selectively controlling a belt-driving means (not shown). It should be understood that the conveyor assembly 50 may be any suitable conveyor system for conveying a theoretically endless supply of mold assemblies 16 to a predetermined position located directly beneath the discharge opening 14 of the hopper 11.

A position sensor assembly 60 may be disposed near the discharge opening 14 of the hopper 11. The position sensor assembly 60 is adapted to detect or sense a leading edge of the mold assembly 16 and provide an output signal indicative of the position of the mold assembly 16 located on the conveyor assembly 50. In the illustrated embodiment, the position sensor assembly 60 is mounted to the hopper frame assembly 40 in a position so as to accurately determine when the mold assembly 16 is in a predetermined position located directly beneath the discharge opening 14 of the hopper 11, although such is not required. The position sensor assembly 60 may be positioned in any manner and may be any sensor suitable to carry out the operation described above. By way of example and not of limitation, the position sensor assembly 60 may be a photocell style sensor assembly or a laser style sensor assembly.

The apparatus 10 includes a control unit 90 which can be any programmable device capable of receiving input signals and generating output signals, such as a general purpose digital computer. The control unit 90 is constructed and adapted to receive the position sensor data output signal 61 provided by the position sensor assembly 60, the load cell data output signal 71 provided by load cell assembly 70, and input data 91 from an operator. The control unit 90 is programmed to generate the open and closed output signals that are received by the discharge gate actuator 21, the vibration output signal that is received by the vibration actuator 31, the conveyor output signal that is received by the conveyor actuator 51, and the supply output signal that is operatively received by the supply actuator 81. The function of the control unit 90 will be described in detail below.

A method of manufacturing molded building products in accordance with this invention is now described. Prior to operation of the apparatus 10, the predetermined quantity of concrete sufficient to adequately fill the unfilled mold assembly 16a is established and the weight of that quantity is computed. During the initial operation of the apparatus 10, the weight of the predetermined quantity is communicated and stored in the control unit 90 as input data 91. The load cell assembly 70 weighs the hopper 11 when the hopper is empty thereby determining an initial tare weight of the hopper 11. The load cell data output signal 71 generated by the load cell assembly 70 is received by the control unit 90, and the control unit is programmed to add the initial tare weight of the hopper 11 with the computed weight of the predetermined quantity of concrete to establish an overall desired weight. The overall desired weight is stored in the control unit 90. The control unit 90 is programmed to compare the tare weight of the hopper 11 with the overall desired weight to determine an unfilled differential. The unfilled differential weight represents the desired amount of concrete to be delivered to the internal cavity 15 of the hopper 11 to adequately fill the unfilled mold assembly 16a.

After measuring the initial tare weight of the hopper 11 and determining the unfilled differential quantity as described above, the control unit 90 is programmed to send an output signal to the supply actuator 81 for causing the concrete transport system 80 to selectively deliver concrete to the internal cavity 15 of the hopper 11. As the concrete is delivered to the internal cavity 15 of the hopper 11, the load cell assembly 70 continuously provides a load cell data output signal 71 indicative of the weight of the concrete being delivered to the internal cavity 15. The data output signal 71 provided by the load cell assembly 70 indicating the weight of the concrete being delivered to the internal cavity 15 of the hopper 11 is received by the control unit 90. The control unit 90 may be programmed with predetermined set points for the measured weight of the concrete delivered into the internal cavity 15 in order to more accurately control the quantity of concrete being delivered to the internal cavity 15. This enables the control unit 90 to reduce the delivery rate of the concrete into the internal cavity 15 as the predetermined quantity of concrete is approached in the internal cavity 15. For example, when the load cell data output signal 71 indicates that the weight of the concrete delivered into the internal cavity 15 of the hopper 11 is equal to the weight of the predetermined set points, the control unit 90 is programmed to provide an output signal to the supply actuator 81 to reduce operation of the concrete transport system 80 accordingly, thereby reducing the delivery rate of concrete into the internal cavity 15. When the load cell data output signal 71 indicates that the weight of the concrete delivered into the internal cavity 15 of the hopper 11 is equal to the weight of the predetermined quantity, the control unit 90 is programmed to provide an output signal to the supply actuator 81 to stop operation of the concrete transport system 80, thereby preventing further delivery of concrete into the internal cavity 15. This delivery process helps to increase the rate of production while also ensuring that the internal cavity 15 of the hopper 11 has accumulated an amount of concrete equal to the predetermined quantity in order to adequately fill the unfilled mold assembly 16a.

Once the predetermined quantity of concrete has been delivered to the internal cavity 15 of the hopper 11, the control unit 90 is programmed to provide an output signal to the vibration actuator 31. The output signal from the control unit 90 to the vibration actuator 31 initiates operation of the vibration inducing mechanism 30. As described above, the vibration inducing mechanism 30 is configured to effectively spread the predetermined quantity of concrete evenly within the internal cavity 15 of the hopper 11. The control unit 90 can be programmed to operate the vibration inducing mechanism 30 for a predetermined amount of time based on the quantity and consistency of concrete within the internal cavity 15.

As the above steps are being performed, the unfilled mold assembly 16a moves along the conveyor assembly 50 in a machine direction of travel indicated by the arrow 52 in FIG. 1. The control unit 90 is programmed to provide an output signal to the conveyor actuator 51 for controlling movement of the conveyor assembly 50. The control unit 90 is programmed to actuate movement of the conveyor assembly 50 until the position sensor assembly 60 senses or detects a leading edge of the unfilled mold assembly 16a. In response to sensing the leading edge of the unfilled mold assembly 16a, a position data output signal 61 is provided by the position sensor assembly 60. The control unit 90 receives the position data output signal 61 from the position sensor assembly 60 indicating that the unfilled mold assembly 16a is properly located in a predetermined position directly beneath the hopper 11. Subsequently, or at that moment, the control unit 90 is programmed to provide an output signal to the discharge gate actuator 21 for actuation. The discharge gate actuator 21 causes the discharge gate 20 to be moved to the opened position in response to receiving the output signal from the control unit 90 thereby causing the concrete stored in the internal cavity 15 of the hopper 11 to be discharged through the discharge opening 14 of the hopper and into the unfilled mold assembly 16a. The hopper 11 may also include a supplemental vibration inducing mechanism (not shown) located on an external portion of the hopper 11, with the supplemental vibration inducing mechanism being configured for activation during discharge to promote full discharge of the concrete from the internal cavity 15. Depending on the production rate (i.e. cycle time) and the rate of discharge from the hopper 11, the control unit 90 may be programmed to temporarily stop or delay movement of the conveyor assembly 50 for a selected amount of time while the unfilled mold assembly 16a is properly located in the predetermined position beneath the hopper 11. This procedure ensures full discharge of the concrete from the internal cavity 15 of the hopper 11 into the now filled mold assembly 16b and also reduces or eliminates unwanted concrete from spilling outside of the filled mold assembly 16b, as might occur if the unfilled mold assembly 16a is moving down the conveyor assembly 50 during the discharging step.

After the discharge gate 20 has been in the opened position for a selected amount of time to ensure full discharge, the control unit 90 is programmed to provide an output signal to the discharge gate actuator 21. In response to receiving the output signal from the control unit 90, the discharge gate actuator 21 moves the discharge gate 20 to a closed position. After providing an output signal to the discharge actuator 21 to close the discharge gate 20, the control unit 90 provides an output signal to the conveyor actuator 51 to continue moving the filled mold assembly 16b down the conveyor assembly 50 in the machine direction 52. As a result, the filled mold assembly 16b continues to move along the conveyor assembly 50 and the process is can be repeated.

It should be noted that not all of the concrete in the internal cavity 15 of the hopper 11 may have been discharged through the discharge opening 14 and into the filled mold assembly 16b. To compensate for this, the load cell assembly 70 weighs the hopper 11 prior to the delivery of the next load of concrete to the hopper 11 in order to determine the operating tare weight of the hopper 11. The operating tare weight of the hopper 11 includes the weight of the hopper 11 and the weight of any residual concrete within the hopper 11. As described above, the control unit 90 is programmed to compare the operating tare weight of the hopper 11 with the overall desired weight so as to determine the unfilled differential quantity required to adequately fill the unfilled mold assembly 16a. This process can be repeated between each and every cycle in order to accurately fill the hopper 11 with the predetermined quantity of concrete.

In accordance with the provisions of the patent statues, the principle and mode of operation of this invention have been explained and illustrated in its preferred embodiment. However, it must be understood that this invention may be practiced otherwise than as specifically explained and illustrated without departing from its spirit or scope.

What is claimed is:

1. A method for discharging a dose of castable building material into a mold, the method comprising the steps of:
(a) introducing a supply of castable building material into a hopper;
(b) controlling the introduction of the castable building material into the hopper to introduce a predetermined quantity;
(c) spreading the castable building material evenly within the hopper;
(d) providing a mold configured to form a molded building product; and
(e) discharging the castable building material from the hopper into the mold.

2. The method of claim 1, wherein the introduction of castable building material within the hopper is controlled by sensing the weight of the castable building material in the hopper.

3. The method of claim 2, wherein the quantity of castable building material in the hopper is continuously sensed as the supply of castable building material is introduced into the hopper.

4. The method of claim 3, wherein the supply of castable building material is selectively introduced into the hopper until the predetermined quantity of castable building material is sensed in the hopper.

5. The method of claim 4, wherein a delivery rate of the castable building material introduced into the hopper is reduced as the quantity of the castable building material sensed in the hopper approaches the predetermined quantity.

6. The method of claim 1 further including the steps of:
weighing the hopper and any residual castable building material within the hopper prior to the introduction of castable building material;
determining an unfilled quantity of castable building material needed to achieve a predetermined quantity of castable building material; and
selectively introducing the castable building material into the hopper until the unfilled quantity of castable building material has been delivered into the hopper.

7. The method of claim 1, wherein the step of spreading the castable building material evenly within the hopper is performed by vibrating the castable building material.

8. The method of claim 7, wherein the step of vibrating the castable building material is performed by submersing a vibration inducing mechanism within the castable building material.

9. The method of claim 8 including the step of moving the vibration inducing mechanism along a horizontal path while the vibration inducing mechanism is submersed within the castable building material.

10. The method of claim 1, wherein the step of spreading the castable building material evenly within the hopper is carried out by a spreader configured to be moved along a horizontal path.

11. The method of claim 1 including evenly discharging the castable building material from the hopper into the mold, thereby substantially reducing the need for lateral movement of the castable building material in the mold to achieve even distribution.

12. The method of claim 11, wherein the hopper discharges a distinct quantity of castable building material at a specified location within the mold having a differing depth than the remainder of the mold.

13. A method for discharging a dose of castable building material into a mold, the method comprising the steps of:
(a) providing a mold configured to form a molded building product;
(b) providing a hopper having a discharge opening, wherein the shape of the discharge opening substantially corresponds to the shape of the mold;
(c) introducing a supply of castable building material into the hopper;
(d) spreading the castable building material evenly within the hopper; and
(e) discharging the castable building material from the hopper evenly into the mold, wherein the even spreading of the castable building material in the hopper substantially reduces the need for lateral movement of the castable building material in the mold.

14. An apparatus for discharging a dose of castable building material into a mold, the apparatus comprising:
(a) a hopper having a discharge opening, the hopper capable of receiving castable building material and discharging the castable building material;
(b) a vibration inducing mechanism configured to evenly spread the castable building material within the hopper;
(c) a mold configured to form a molded building product, the mold being positioned beneath the hopper; and
(d) a discharge gate connected to the hopper and in direct communication with the discharge opening, the discharge gate configured to discharge the castable building material evenly into the mold while substantially reducing the need for lateral movement of the castable building material in the mold.

15. The apparatus of claim 14 further including a load cell assembly configured to sense the weight of the castable building material in the hopper.

16. The apparatus of claim 14, wherein the vibration inducing mechanism is mounted for submersion within the castable building material.

17. The apparatus of claim 16, wherein the vibration inducing mechanism is configured to move along a horizontal path while submersed within the castable building material.

18. The apparatus of claim 14, wherein the hopper is configured to discharge a distinct quantity of castable building material at a specified location within the mold, wherein the specified location has a differing depth than the remainder of the mold.

19. The apparatus of claim 14, wherein the discharge gate is connected to an external portion of the hopper by a hinge, and wherein the hinge is located a spaced distance from the discharge opening.

20. The apparatus of claim 14, wherein the discharge opening defines a plane that is angled relative to a horizontal plane to provide added support for sealing between the discharge opening and the discharge gate.
